(19) United States
(12) Patent Application Publication
(10) Pub. No.: US 2008/0070096 A1
(43) Pub. Date: Mar. 20, 2008

(54) Proton Conducting Copolymers

(76) Inventors: Lucia Daniela Ionescu, Alkmaar (NL); Andre Wakker, Bloemendaal (NL)

Correspondence Address: FOLEY AND LARDNER LLP;SUITE 500, 3000 K STREET NW, WASHINGTON, DC, 20007, US

(21) Appl. No.: 11/573,124

(22) PCT Filed: Aug. 9, 2005
(86) PCT No.: PCT/NL05/00578

§ 371 Date: Dec. 5, 2007

(30) Foreign Application Priority Data
Aug. 9, 2004 (EP) 04077266.7

(51) Int. Cl. C08J 5/22; H01M 8/02

(52) U.S. Cl. 429/46; 521/27

(57) ABSTRACT

The present invention relates to proton conducting copolymers, preferably proton conducting block copolymers, according to formula (I) wherein the copolymer comprises 2,5- and/or 2,6-di(p-R¹-aryl)phenol moieties and 2,5- and/or 2,6-di-R²-phenol moieties; R¹ is hydrogen or a C₁-C₁₀alkyl group; R² is a C₁-C₁₀ alkyl group; and R³ is chloro, bromo or a heterocyclic group selected from 1-pyrazolyl, 1-benzopyrazolyl, 1-imidazolyl, 1-benzoimidazolyl, 2,3-triazol-1-yl, 2,4-triazol-1-yl, 1,6-dihydropyridazin-1-yl, 1,2-dihydropyrimidin-1-yl, 1,2-dihydro-1,3-benzodiazin-1-yl, 1,2-dihydropyrazin-1-yl, 1,2-dihydro-1,4-benzodiazin-1-yl, 1,2-dihydro-1,3,5-triazin-1-yl and 3,4-dihydro-1,2,4-triazinyl, provided that within the copolymer at least one R³ is a heterocyclic group; p is in the range of 100 to 100.000; and q is in the range of 100 to 100.000. The proton conducting copolymers are very suitable as membranes for fuel cells.

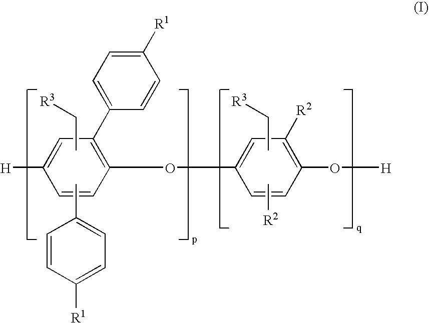

### FIELD OF THE INVENTION

The present invention relates to copolymers prepared from 2,5- and/or 2,6-disubstituted phenol derivatives, a process for preparing such a copolymer by oxidation coupling polymerization, proton conducting copolymers prepared from the copolymers, a process for preparing the proton conducting copolymers and membranes and fuel cells comprising the proton conducting copolymers.

### BACKGROUND OF THE INVENTION

PEM (“PEM” means Polymer Electrolyte Membrane or Proton Exchange Membrane) fuel cells such as are known from U.S. Pat. No. 5,928,807 are equipped with semi-permeable membranes, which separate an anode compartment and a cathode compartment of the fuel cell from one another, but are designed to enable the transport of protons from the anode to the cathode.

The state of the art PEM fuel cell technology is not good enough to approach cost and functionality targets, in particular for the fuel cell industry's biggest potential market, i.e. the transport sector. The currently most used membranes that are based on Nafion® perfluorosulfonic acid ionomers having the general structure (Butler, G. B.; O'Driscoll, K. F.; Wilkes, G. L. JMS-Rev. Macromol. Chem. Phys. 1994, C34 (3), 325-373):

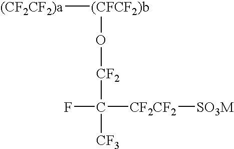

Although Nafion® is primarily used as an ion exchange membrane in the chlorine-alkali industry, it has boosted automotive FC (“FC” means Fuel Cell) applications because of low temperature operation and cold start capability. Also, the membrane is forgiving for intensive temperature cycling.

However, the main problem with the Nafion® membrane is that it needs 100% water saturation (i.e. a 100% RH environment) to achieve for the PEM fuel cell the required (high) proton conductivity. In fact, water is the proton conducting phase in the Nafion® membrane. This holds for alternative, sulfonated ionomers (S-PEEK, S-PES) as well. Not only does the humidification of PEM fuel cells operating at about 70°-80° C. add to system cost and complexity, but it also makes operation above 100° C. virtually impossible due to the water loss from the Nafion® membrane. Proton conductivity at these higher temperatures is a prerequisite for better performance of PEM fuel cells. In particular, the (rather low) cooling efficiency of the FC engine increases with increasing FC temperature, and the CO tolerance of the PEM FC even increases dramatically with increasing operating temperature. The latter is particularly relevant when (on-board) reformate is the fuel. Typical target temperatures, also depending on the cooling concept, are in the range of about 120° C. up to about 150° C.

So-called hybrid Nafion® membranes are a technology option that has been investigated some years now, so far without much success. Such membranes are in fact Nafion® membranes filled with materials that (further) increase the water retention of Nafion. The hope is to obtain a membrane that has the required proton conductivity in the relevant temperature range and at the same time at RH levels as low as 40% to 20%, or even lower.

U.S. Pat. No. 5,525,436 and U.S. Pat. No. 5,716,727 disclose PBI (“PBI” means polyimidazole) and similar polymers as proton conductive polymers that can be used for the manufacture of membranes for fuel cells. Whilst PBI membranes doped with phosphoric acid are another, and promising, technology option, and do indeed operate without any humidification and typically at temperatures of 150° C. or higher, it is in fact a quasi-PAFC (“PAFC” means Phosphoric Acid Fuel Cell), with similar draw-backs: large cathode losses, limited thermal cyclability and life issues related to the leaching of the acid. PBI based MEA's are currently being co-developed by Celanese and Honda, and are restrict on the market.

The object of the present invention is to overcome the drawbacks indicated above. In particular, the present invention provides a new class of proton conducting copolymers that can be used for high temperature PEM fuel cell applications.

### SUMMARY OF THE INVENTION

The present invention relates to a proton conducting copolymer according to formula (I): 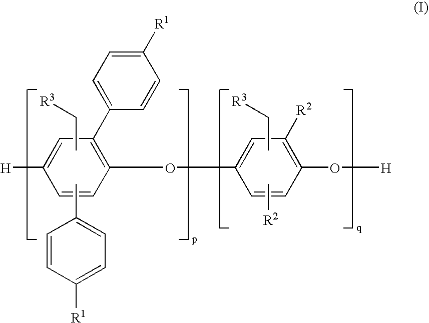
wherein:
the copolymer comprises 2,5- and/or 2,6-di(p-R¹-aryl)phenol moieties and 2,5- and/or 2,6-di-R²-phenol moieties;
R¹ is hydrogen or a C₁-C₁₀ alkyl group;
R² is a C₁-C₁₀ alkyl group;
R³ is chloro, bromo or a heterocyclic group selected from 1-pyrazolyl, 1-benzopyrazolyl, 1-imidazolyl, 1-benzoimidazolyl, 2,3-triazol-1-yl, 2,4-triazol-1-yl, 1,6-dihydropyridazin-1-yl, 1,2-dihydropyrimidin-1-yl, 1,2-dihydro-1,3-benzodiazin-1-yl, 1,2-dihydropyrazin-1-yl, 1,2-dihydro-1,4-benzodiazin-1-yl, 1,2-dihydro-1,3,5-triazin-1-yl and 3,4-dihydro-1,2,4-triazinyl, provided that within the copolymer at least one R is a heterocyclic group;
p is in the range of 100 to 100.000; and
q is in the range of 100 to 100.000.

The present invention further relates to a process for the preparation of a proton conducting polymer according to formula (I), a membrane comprising a proton conducting copolymer according to formula (I) and a fuel cell comprising said membrane.

The invention further comprises copolymers according to formula (II): 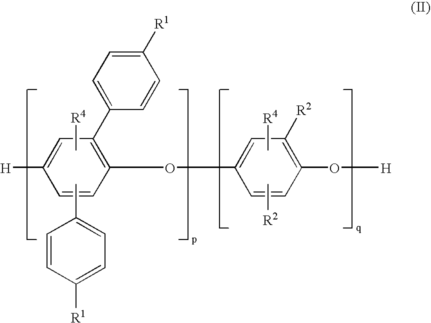
wherein R¹ is hydrogen or a C₁-C₁₀ alkyl group;
R² is a C₁-C₁₀ alkyl group;
R⁴ is hydrogen or a —CH₂X group wherein X is chloro or bromo, provided that within the copolymer at least one R⁴ is a —CH₂X group;
p is in the range of 100 to 100.000; and
q is in the range of 100 to 100.000.

The present invention finally relates to a process for the preparation of the copolymers according to formula (II) and the use thereof for the preparation of proton conducting copolymers.

### DETAILED DESCRIPTION OF THE INVENTION

Copolymer

The starting materials used for the preparation of the proton conductive polymers are copolymers, preferably block copolymers, from substituted phenol derivatives which can be polymerised by the well known oxidative coupling polymerisation. Random copolymers of such phenol derivatives are for example disclosed in U.S. Pat. No. 3,257,357, U.S. Pat. No. 3,733,307 and U.S. Pat. No. 4,207,406. U.S. Pat. No. 5,037,943 discloses a process for the manganese polymerisation of 2,6-disubstituted phenol compounds which may be copolymerised with 2,3,6-trimethylphenol. The disclosure of U.S. Pat. No. 5,159,018 encompasses a broad class of random copolymers prepared from phenol compounds having substituents R₁-R₅, wherein R₁-R₅ are independently selected from hydrogen, halogen, substituted or unsubstituted hydrocarbon residues containing 1-18 carbon atoms, substituted or unsubstituted aryl groups such as phenyl groups, benzyl groups or allyl groups. However, U.S. Pat. No. 5,159,018 does not disclose explicitly the preferred copolymers according to the present invention. Additionally, U.S. Pat. No. 6,576,800 discloses in Table 2 random copolymers of phenol monomers that are substituted at position 2 by long chain alkyl groups whereas US 2003/0225220 discloses the synthesis of random copolymers of three different phenol monomers. The US patents and patent applications mentioned here are all incorporated by reference for the US patent practice.

According to the present invention, the copolymers according to formula (II) may be random copolymers, tapered copolymers or block copolymers. However, it is preferred that the copolymers are block copolymers, and that they preferably comprise 2,6-di(p-R¹-aryl)phenol moieties, wherein the aryl group comprises 6-12 carbon atoms and wherein the aryl group may be unsubstituted or substituted with independently one or more C₁-C₆ alkyl groups or halogen atoms. The alkyl groups may me linear, branched or cyclic. Suitable alkyl groups include methyl, ethyl, n- and i-propyl, n-, s- and t-butyl, pentyl, hexyl, cyclohexyl and the like. The halogen atoms may be chlorine of bromine atoms. Most preferably, the aryl group is phenyl which implies that R¹ is most preferably hydrogen and that the aryl groups are unsubstituted.

It is furthermore preferred that the copolymers, preferably block copolymers, comprise 2,6-di-R²-phenol moieties. In the copolymers according to the invention, R² is independently selected from C₁-C₁₀ alkyl groups, wherein the alkyl groups may me linear, branched or cyclic. Suitable alkyl groups include methyl, ethyl, n- and i-propyl, n-, s- and t-butyl, pentyl, hexyl cyclohexyl and the like. Preferably, R² is selected from C₁-C₆ alkyl and most preferably R² is methyl.

Hence, according to a more preferred embodiment of the present invention, the copolymer is a block copolymer comprising a first block of 2,6-di(p-R¹-aryl)phenol moieties and a second block of 2,6-di-R²-phenol moieties. Even more preferred is that the copolymer according to the present invention is a diblock copolymer comprising a first block of 2,6-di(p-R¹-aryl)phenol and a second block of 2,6-di-R²-phenol moieties. Most preferably, the copolymer according to the present invention is a diblock copolymer consisting of a first block of 2,6-di(p-R¹-aryl)phenol moieties and a second block of 2,6-di-R²-phenol moieties.

The number average molecular weight of the copolymers according to the invention as determined by GPC is preferably within the range of 1000 to 1.000.000.

In formulae (I) and (II) p and q are within the range of 100 to 100.000. A more preferred range is 1000-50.000 and an even more preferred range is 2000-25.000.

According to the invention, it is preferred that the ratios of p and q are between 5:1 to 1:5, more preferably 2:1 to 1:2 and most preferably 1.5:1 to 1:1.5.

The copolymers according to the present invention are prepared by simultaneous or subsequent polymerisation of a 2,5- and/or 2,6-di(p-R¹-aryl)phenol derivative and a 2,5- and/or 2,6-di-R²-phenol derivative under oxidative coupling polymerisation conditions.

Since the preferred copolymers are block copolymers, the block copolymers according to the present invention are preferably prepared by a sequential oxidation coupling polymerisation, wherein the process comprises the following steps:
(a) polymerising a 2,5- and/or 2,6-di(p-R¹-aryl)phenol derivative under oxidative coupling polymerisation conditions; and
(b) polymerising a 2,5- and/or 2,6-di-R-phenol derivative under oxidative coupling polymerisation conditions to obtain a block copolymer comprising a first block comprising 2,5- and/or 2,6-di(p-R¹-aryl)phenol moieties and a second block comprising 2,5- and/or 2,6-di-R²-phenol moieties.

Preferably, the polymerisation is carried out with oxygen and CuBr as the catalyst in the presence of tetramethylene ethylene diamine (TMEDA). The polymerisation is preferably conducted at a temperature in the range of 40° to 100°, more preferably at a temperature in the range of 50° to 70° C. Additionally, the each step of the polymerisation is preferably performed for a period of 1 to 10 h, preferably 3 to 8 h.

Halomethylation

The halomethylation of aryl compounds is an electrophilic aromatic substitution reaction well known in the art and can for example be performed with formaldehyde, HCl and ZnCl₂ (Fuson, R. C.; McKeever, C. H.; Org. React. 1942, 1, 63; Olah, G. A.; Yu, S. H.; J. Am. Chem. Soc. 1975, 97, 2293). According to the present invention, this reaction is preferably a chloromethylation reaction. The chlorine content of the chloromethylated copolymer, preferably chloromethylated block copolymer, is preferably within the range of about 15 to about 30% wt, based on the total weight of the copolymer. The halomethylation is preferably conducted at a temperature in the range of 25° C. to 75° C. during a period of about 1 to 10 h, preferably 2 to 8 h.

Since this reaction is an electrophilic aromatic substation, reaction mainly occurs at the phenol rings as was established by NMR spectroscopy. So the structure of the most preferred embodiment of the invention is: 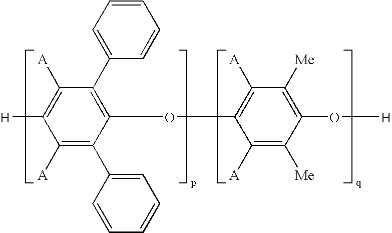
wherein A is —CH₂Cl. However, side products formed in minor quantities may comprise products wherein the phenyl substituents of the phenol rings are substituted and such products are also within the scope of the invention.
Reaction of Halomethylated Copolymer with Heterocyclic Compound

The halomethylated, preferably chloromethylated, copolymer is reacted with a heterocyclic compound comprising at least a basic nitrogen atom, i.e. a NH moiety, to allow alkylation of the heterocyclic moiety by the halomethylene group, preferably chloromethylene group. The heterocyclic moiety is selected from the group consisting of pyrazole, benzopyrazole, imidazole, benzoimidazole, 1,2,3-triazole, 1,2,4-triazole, 1,6-dihydropyridazine, 1,2-dihydropyrimidine, 1,2-dihydro-1,3-benzodiazine, 1,2-dihydropyrazine, 1,2-dihydro-1,4-benzodiazine, 1,2-dihydro-1,3,5-triazine and 3,4-dihydro-1,2,4-triazine. According to the invention, the heterocyclic group is preferably imidazole, benzimidazole. or a mixture thereof.

This reaction is preferably performed at a temperature in the range of −20° to 20° C., more preferably in the range of −10° C. to 10° C., for about 1 to about 10 h, more preferably for about 2 to about 8 h.

Proton Conducting Copolymer

The proton conducting copolymer according to the invention has the formula (I) as shown above and may be a random copolymer, a tapered copolymer or a block copolymer. However, it is preferred that the proton conducting copolymer is a block copolymer as disclosed above. According to the present invention, the proton conducting copolymers preferably comprises 2,6-di(p-R¹-aryl)phenol moieties, wherein the aryl group comprises 6-12 carbon atoms and wherein the aryl group may be unsubstituted or substituted with independently one or more C₁-C₆ alkyl groups or halogen atoms. Most preferably, the aryl group is phenyl.

In the proton conducting copolymers according to the invention R¹ is independently selected from C₁-C₁₀ alkyl groups, wherein the alkyl groups may me linear, branched or cyclic. Preferably, R² is selected from C₁-C₆ alkyl and most preferably R² is methyl.

When R³ is a heterocyclic group, it is preferred that R³ is 1-imidazolyl or 1-benzoimidazolyl.

The number average molecular weight of proton conducting copolymers according to the invention as determined by GPC is preferably within the range of 1000 to 1.000.000.

In formula (I) p and q are within the range of 100 to 100.000. A more preferred range is 1000-50.000 and an even more preferred range is 2000-25.000.

According to the invention, it is preferred that the ratios of p and q are between 5:1 to 1:5, more preferably 2:1 to 1:2 and most preferably 1.5:1 to 1:1.5.

It is preferred that at least 40% of the R¹ groups is a heterocyclic group, more preferably at least 50% and most preferably at least 75%.

For conductivity measurements, the proton conducting copolymers according to the invention are doped with a strong acid, preferably sulphuric acid, phosphoric acid or polyphosphoric acid, more preferably phosphoric acid or polyphosphoric acid.

The proton conducting copolymers according to this invention and in particular the proton conducting block copolymers are very suitable for use in high temperature PEM fuel cell applications. The invention therefore also relates to a membrane comprising the proton conducting copolymer according to the present invention. More in particular, the invention therefore relates to a reinforced membrane comprising the proton conducting copolymer as proton conducting phase. The invention also relates to fuel cells comprising the membrane, in particular the reinforced membrane. The invention further relates to fuel cell electrodes comprising the proton conducting copolymers.

### EXAMPLE 1

In this Example, the synthesis of a block polymer from 2,6-diphenyl phenol and 2,6-dimethyl phenol having a Mₙ of about 20000 (each block has a Mₙ of about 10000) is disclosed.

In a three neck round bottomed flask are introduced 6 mg of CuBr, 8 mg TMEDA and 2 g solvent (chlorobenzene) under stirring and a 5 ml/min. oxygen flow. The mass reaction was kept for 20-30 minutes at 60° C. under reflux and oxygen flow. Then 2 g 2,6-diphenyl phenol were dissolved in 4 g chlorobenzene and the solution resulted was very slowly added to the three neck bottomed flask. The same oxygen flow was used further and the reaction was carried out for 5 hours. The reaction was continued by adding the appropriate amount of the second monomer 2,6-dimethyl phenol and the reaction time is 3 hours in this second step. The final polymer was purified by repeated dissolution in chloroform and precipitation in methanol until a slightly yellowish product was obtained. The product was characterized by GC, GPC, FTIR, NMR, TGA, DSC. In this way copolymers were obtained wherein the ratio of p to q was 1:1.5 and wherein the copolymers has a Mₙ in the range of 20.000 to 75.000.

### EXAMPLE 2

In this example a typical procedure of the chloromethylation of the block copolymer is disclosed.

An amount of 2 g of the block polymer having a Mₙ of 20.000 as obtained in Example 1 is dissolved for 1 h at 35° C. in 5 g methylal (dimethoxy methane or CH2(MeO)₂) in a reflux flask. After cooling to room temperature, 6 g thionyl chloride and 1 g ZnCl₂ were gradually introduced into the reaction medium under stirring and cooling. The temperature was then brought up to 45° C. and the reaction was carried out for 6 hours. At the end of the reaction, the reaction mass was cooled and water was gradually introduced in order to decompose the reactants that were still present in the reaction mass. The chloromethylated copolymer had a chlorine content of 18.4% as determined with an ion chromatograph after burning a sample in a boom and by a coulometric titration after burning the sample at 1200° C. The chloromethylation can also be performed by using SnCl₄ instead of ZnCl₂.

### EXAMPLE 3

In this example a typical procedure of the reaction of chloromethylated block copolymers with imidazole is disclosed.

After the chlomethylated block polymer as obtained in Example 2 was dried, it was used in a reaction with imidazole as follows: 1.25 g imidazole (corresponding to a 100% functionalisation) was dissolved in THF and introduced in a three neck round bottomed flask. The temperature of the flask was brought with the aid of ice to 0° C. and the content of the flask was kept under nitrogen for about 20 minutes. Then a solution of 2 g chloromethylated block copolymer in 5 g THF was slowly added drop wise into the flask while monitoring the temperature, which should not pass 5° C. Normally a rather strong exothermic effect is observed during the addition of the block copolymer solution and after the polymer addition was completed, the reaction was continued for 2 h. Then the mass reaction is filtrated and the polymer recovered after solvent evaporation. The structure of the final product was investigated by NMR and FTIR. Thermal behaviour was also investigated by TGA and DSC. Corresponding polymers having 100%, 75%, 50%, 25%, 0% % imidazole functionalisation were obtained following the same procedure.

### EXAMPLE 4

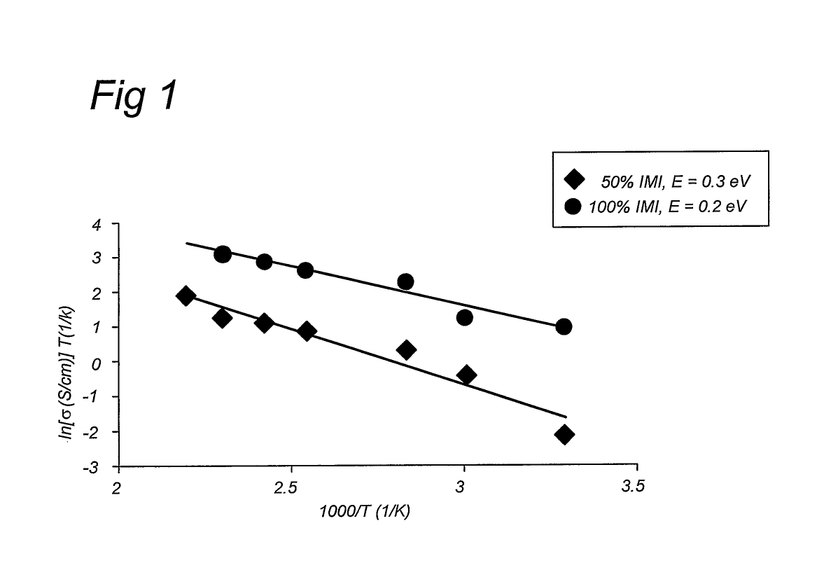

The proton conductive block copolymers obtained in Example 3 were mixed in a THF solution with polyphosphoric acid (PPA) (proton source in this model systems). Subsequently, the solvent was evaporated and the solid material remained was hot-pressed at 105° C. in the form of a tablet having a diameter of 12 mm and a thickness of between about 0.16 to about 0.20 cm. The tablets were kept for 3 days in the oven at a temperature of about 80° to 90° C. The conductivity of the tablets was determined by using a homemade set up which was connected with an impedance spectroscopy device. The tablet was placed between 2 gold electrodes which were part of the setup which after fixing the tablet was closed and placed in an oven and then connected to the EIS device. EIS measurements from room temperature to about 180° C. were done in a dry atmosphere and proton conductivities of 0.05 S/cm at 180° C. were found. Cycles in the this temperature range were performed and the results were reversible and reproducible with an Arrhenius temperature dependence which is characteristic for intrinsic proton conductivity (cf. FIG. 1): 50% IMI: y=−3.2572*x+9.0741, R²=0.94; 100% IMI: y=−2.2765*x+8.3998, R²=0.95. The activation energy of the proton conduction process was the lowest for the highest imidazole content and the highest for 0% imidazole in the proton conducting block copolymer.

Results of EIS Measurements:

Imidazole functionalised polymer, with different imidazole contents, mixed with poly phosphoric acid (PPA) as proton source, having a ratio imidazole/PPA per cm³ tablet=1.83 and a volume fraction ratio polymer/PPA=8.8. Measurements of conductivity have been done using Impedance Spectroscopy in a fully dry atmosphere (RH=0%)

| Temp. | σ_{100% imi} | σ_{75% imi} | σ_{50% imi} | σ_{25% imi} | σ_{0% imi} |
|---|---|---|---|---|---|
| (° C.) | (S/cm) | (S/cm) | (S/cm) | (S/cm) | (S/cm) |
| 30 | 7.9 × 10⁻³ | 1.6 × 10⁻³ | 1.2 × 10⁻⁴ | 8.0 × 10⁻⁶ | 1.0 × 10⁻⁷ |
| 60 | 9.5 × 10⁻³ | 4.3 × 10⁻³ | 2.3 × 10⁻⁴ | 3.0 × 10⁻⁵ | 2.0 × 10⁻⁶ |
| 80 | 1.0 × 10⁻² | 5.5 × 10⁻³ | 9.0 × 10⁻⁴ | 3.3 × 10⁻⁵ | 4.0 × 10⁻⁶ |
| 120 | 2.5 × 10⁻² | 1.0 × 10⁻² | 1.4 × 10⁻³ | 5.0 × 10⁻⁵ | 5.3 × 10⁻⁶ |
| 140 | 3.3 × 10⁻² | 1.2 × 10⁻² | 1.8 × 10⁻³ | 6.0 × 10⁻⁵ | 6.6 × 10⁻⁶ |
| 160 | 4.1 × 10⁻² | 1.4 × 10⁻² | 2.2 × 10⁻³ | 7.0 × 10⁻⁵ | 8.2 × 10⁻⁶ |
| 180 | 5.0 × 10⁻² | 2.0 × 10⁻² | 2.5 × 10⁻³ | 9.0 × 10⁻⁵ | 1.0 × 10⁻⁵ |

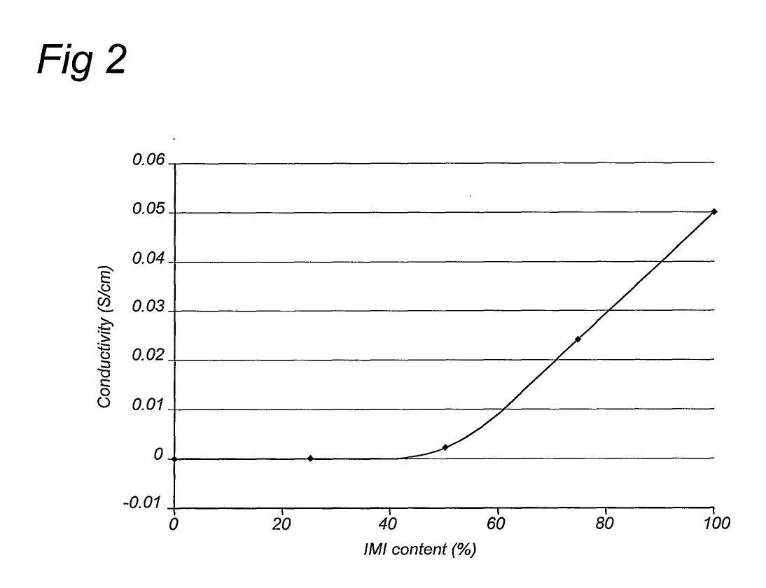

In FIG. 2 the dependence of the conductivity upon imidazole content at 180° C. is shown.

1-25. (canceled)

26. A proton conducting copolymer according to formula (I): 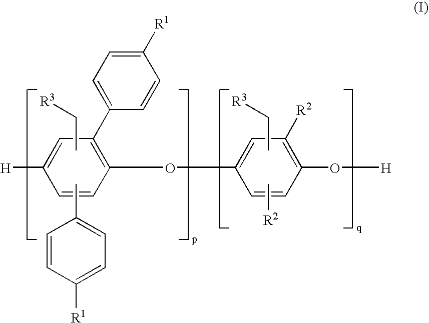
wherein:
the copolymer comprises 2,5- and/or 2,6-di(p-R¹-aryl)phenol moieties and 2,5- and/or 2,6-di-R²-phenol moieties; and wherein:
R¹ is hydrogen or a C₁-C₁₀ alkyl group;
R² is a C₁-C₁₀ alkyl group;
R³ is chloro, bromo or a heterocyclic moiety selected from the group consisting of 1-pyrazolyl, 1-benzopyrazolyl, 1-imidazolyl, 1-benzoimidazolyl, 2,3-triazol-1-yl, 2,4-triazol-1-yl, 1,6-dihydropyridazin-1-yl, 1,2-dihydropyrimidin-1-yl, 1,2-dihydro-1,3-benzodiazin-1-yl, 1,2-dihydropyrazin-1-yl, 1,2-dihydro-1,4-benzodiazin-1-yl, 1,2-dihydro-1,3,5-triazin-1-yl and 3,4-dihydro-1,2,4-triazinyl, provided that within the copolymer at least one R³ is a heterocyclic group;
p is in the range of 100 to 100,000; and
q is in the range of 100 to 100,000.

27. The proton conducting copolymer according to claim 25, wherein the copolymer is a block copolymer.

28. The proton conducting copolymer according to claim 25, wherein the copolymer comprises 2,6-di(p-R¹-aryl)phenol moieties.

29. The proton conducting copolymer according to claim 25, wherein the copolymer comprises 2,6-di-R²-phenol moieties.

30. The proton conducting copolymer according to claim 25, wherein R¹ is hydrogen.

31. The proton conducting copolymer according to claim 28, wherein R¹ is hydrogen.

32. The proton conducting copolymer according to claim 25, wherein R² is methyl.

33. The proton conducting copolymer according to claim 29, wherein R² is methyl.

34. The proton conducting copolymer according to claim 25, wherein R³ is chloro, bromo, 1-imidazolyl or 1-benzoimidazolyl.

35. The proton conducting copolymer according to claim 28, wherein R³ is chloro, bromo, 1-imidazolyl or 1-benzoimidazolyl.

36. The proton conducting copolymer according to claim 31, wherein R³ is chloro, bromo, 1-imidazolyl or 1-benzoimidazolyl.

37. The proton conducting copolymer according to claim 29, wherein R³ is chloro, bromo, 1-imidazolyl or 1-benzoimidazolyl.

38. The proton conducting copolymer according to claim 33, wherein R³ is chloro, bromo, 1-imidazolyl or 1-benzoimidazolyl.

39. The proton conducting copolymer according to claim 25, wherein the copolymer has a number average molecular weight in the range of 1,000 to 1,000,000.

40. The proton conducting copolymer according to claim 25, wherein the ratio of p and q is between 2:1 to 1:2.

41. The proton conducting copolymer according to claim 25, wherein at least 40% of the R³ groups is a heterocyclic group.

42. A process for the preparation of a proton conducting copolymer according to formula (I): 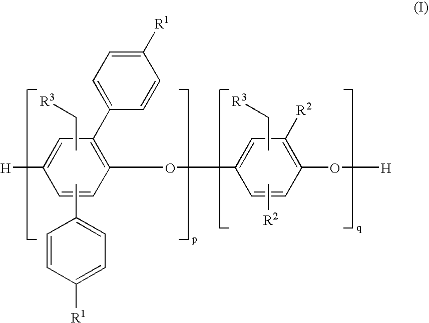
wherein:
the proton conducting copolymer comprises 2,5- and/or 2,6-di(p-R¹-aryl)phenol moieties and 2,5- and/or 2,6-di-R²-phenol moieties;
R¹, R², R³, p and q are defined as in claim 1;
the process comprising:
(a) polymerizing a 2,5- and/or 2,6-di(p-R¹-aryl)phenol derivative and a 2,5- and/or 2,6-di-R²-phenol derivative under oxidative coupling polymerization conditions;
(b) subjecting the copolymer of (a) to halomethylation conditions to obtain a halomethylated copolymer; and
(c) reacting the halomethylated copolymer of (b) with a heterocyclic compound, wherein the heterocyclic compound is selected from the group consisting of pyrazole, benzopyrazole, imidazole, benzoimidazole, 1,2,3-triazole, 1,2,4-triazole, 1,6-dihydropyridazine, 1,2-dihydropyrimidine, 1,2-dihydro-1,3-benzodiazine, 1,2-dihydropyrazine, 1,2-dihydro-1,4-benzodiazine, 1,2-dihydro-1,3,5-triazine and 3,4-dihydro-1,2,4-triazine.

43. A process for the preparation of a proton conducting copolymer according to formula (I): 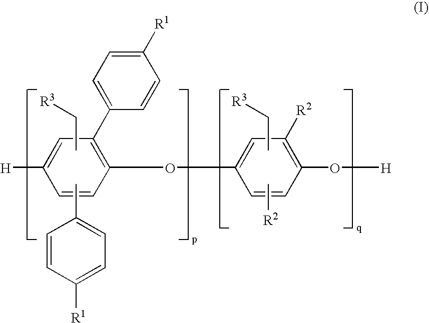
wherein the proton conducting copolymer is a block copolymer and comprises 2,5- and/or 2,6-di(p-R¹-aryl)phenol moieties and 2,5- and/or 2,6-di-R²-phenol moieties;
R¹, R², R³, p and q are defined as in claim 1; and
wherein the process comprises:
(i) polymerising a 2,5- and/or 2,6-di(p-R¹-aryl)phenol derivative under oxidative coupling polymerisation conditions;
(ii) polymerising a 2,5- and/or 2,6-di-R²-phenol derivative under oxidative coupling polymerisation conditions to obtain a block copolymer comprising a first block comprising 2,5- and/or 2,6-di(p-R¹-aryl)phenol moieties and a second block comprising 2,5- and/or 2,6-di-R²-phenol moieties;
(iii) subjecting the block copolymer as obtained in step (b) to halomethylation conditions to obtain a halomethylated block copolymer; and
(iv) reacting the halomethylated block copolymer with a heterocyclic compound, wherein the heterocyclic compound is selected from the group consisting of pyrazole, benzopyrazole, imidazole, benzoimidazole, 1,2,3-triazole, 1,2,4-triazole, 1,6-dihydropyridazine, 1,2-dihydropyrimidine, 1,2-dihydro-1,3-benzodiazine, 1,2-dihydropyrazine, 1,2-dihydro-1,4-benzodiazine, 1,2-dihydro-1,3,5-triazine and 3,4-dihydro-1,2,4-triazine.

44. The process according to claim 43, wherein steps (a), (i) and (ii) of the process are conducted at a temperature in the range of 40° to 100° C.

45. The process according to claim 43, wherein steps (b) and (iii) are conducted at a temperature in the range of 25° C. to 75° C.

46. The process according to claim 43, wherein steps (c) and (iv) are conducted at a temperature in the range of −20° to 20° C.

47. A copolymer according to formula (II): 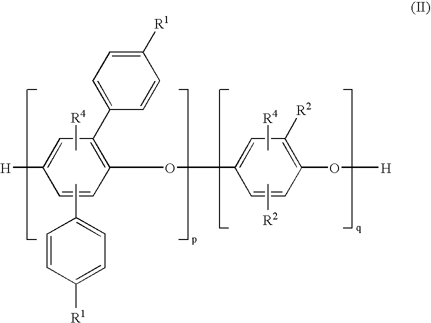
wherein
R¹ is hydrogen or a C₁-C₁₀ alkyl group;
R² is a C₁-C₁₀ alkyl group;
R⁴ is hydrogen or a —CH₂X group, wherein X is chloro or bromo, provided that within the copolymer at least one R⁴ is a —CH₂X group;
p is in the range of 100 to 100,000; and
q is in the range of 100 to 100,000.

48. The copolymer according to claim 47, wherein the copolymer is a block copolymer.

49. The copolymer according to claim 47, wherein the copolymer has a number average molecular weight of 1,000 to 1,000,000.

50. The copolymer according to claim 47, wherein the ratio of p and q is between 2:1 and 1:2.

51. The copolymer according to claim 47, wherein R¹ is hydrogen, R² is methyl and X is chloro.
